(19) United States
(12) Patent Application Publication
(10) Pub. No.: US 2012/0222074 A1
(43) Pub. Date: Aug. 30, 2012

(54) METHODS AND SYSTEMS FOR PROVIDING ELECTRONIC PROGRAM GUIDE DATA

(76) Inventors: Stewart Lyle Mix, Cochrane (CA); John Anderson Chamard, Calgary (CA); Jacek Rafal Krzywicki, Calgary (CA)

(21) Appl. No.: 13/036,729

(22) Filed: Feb. 28, 2011

(51) Int. Cl. H04N 21/482

(52) U.S. Cl. 725/54

(57) ABSTRACT

Methods and systems for providing and displaying electronic program guide (EPG) data. Generalized program objects are generated based on EPG data. The generalized program objects are transmitted to set-top boxes for displaying in an EPG menu. When a user navigates the EPG menu to select a program, a query is transmitted to a query server, which returns additional information regarding the selected program in a response. The additional information may be used in an order confirmation dialog displayed to the user.

### FIELD

The embodiments described herein relate to the field of electronic program guides and, in particular to methods and systems for providing electronic program guide data.

### INTRODUCTION

Electronic program guides are used widely in conjunction with a variety of content delivery services, such as television, online, and radio. Generally speaking, electronic program guides are accessible by users of such services and display scheduling information for current and upcoming programming. Some electronic program guides can also be used to display information and selection information for video-on-demand content. Electronic program guides may be periodically or continuously updated to ensure that the most up-to-date information is available upon demand.

An interactive electronic programming guide (EPG) enables a user of a content delivery service to navigate through scheduling information using an input device, such as a television remote control, to select and discover programming content. Content may be selected according to various criteria, including time, title, channel and genre. Data for generating an interactive electronic program guide data may be distributed to terminal devices, such as set-top boxes, for example via a cable or satellite network.

### SUMMARY

In one broad aspect, there is provided a method of providing EPG data. The method can comprise generating a plurality of generalized program objects based on a plurality of program assets in the EPG data; transmitting the plurality of generalized program objects from a distribution device to a plurality of client devices; receiving, at a server, a query from a first client device of the plurality of client devices, the query identifying a first generalized program object from the plurality of generalized program objects; and providing, from the server to the first client device, a program metadata object associated with the first generalized program object, the program metadata object comprising additional data associated with the first generalized program object. The distribution device may be a cable headend. The plurality of generalized program objects may be transmitted to the plurality of client devices via a cable plant.

Prior to generating the plurality of generalized program objects, the method may further comprise receiving the EPG data; and identifying a set of program entries in the EPG data, each of the set of program entries associated with a specific program asset, wherein only one of the plurality of generalized program objects is generated based on the set of program entries.

Prior to providing the program metadata object, the method may further comprise determining at least one device capability of the first client device or determining at least one account option associated with a user of the first client device

The query may identify at least one device capability of the first client device or at least one account option associated with a user of the first client device. The at least one account option may include a subscription. The query may comprise at least one data packet received from the first device via an IP network.

The additional data associated with the first generalized program object may be based on the at least one device capability of the first client device or the at least one account option associated with a user of the first client device.

In another broad aspect, there is provided a method of displaying EPG data on a client device. The method may comprise: receiving a plurality of generalized program objects based on a plurality of program assets; displaying the plurality of generalized program objects in an EPG menu; receiving a selection of a first generalized program object from the plurality of generalized program objects; generating a query identifying the first generalized program object; transmitting the query to a server; receiving, from the server, a program metadata object associated with the first generalized program object, the program metadata object comprising additional data associated with the first generalized program object; and displaying data from the program metadata object in association with the first generalized program object in an order confirmation dialog. The query may identify at least one device capability of the client device. The plurality of generalized program objects may be received from a cable plant.

Prior to transmitting the query, the method may further comprise determining at least one device capability of the client device. The query may comprise at least one data packet transmitted to the server via an IP network.

In yet another broad aspect, there is provided a system for providing and displaying EPG data. The system may comprise: an EPG configuration module, the EPG configuration module configured to generate a plurality of generalized program objects based on a plurality of program assets associated with the EPG data; at least one distribution device, the distribution device configured to transmit the plurality of generalized program objects to a plurality of client devices; a server configured to received a query identifying a first generalized program object from the plurality of generalized program objects and transmit a program metadata object associated with the first generalized program object; and a first client device in the plurality of client devices, the first client device configured to: receive the plurality of generalized program objects; display the plurality of generalized program objects in an EPG menu; receive a selection of the first generalized program object from the plurality of generalized program objects; generate the query identifying the first generalized program object; transmit the query to the server; receive, from the server, the program metadata object associated with the first generalized program object; and display data from the program metadata object in association with the first generalized program object in an order confirmation dialog.

### DRAWINGS

For a better understanding of embodiments of the systems and methods described herein, and to show more clearly how they may be carried into effect, reference will be made, by way of example, to the accompanying drawings in which:

FIG. 1 illustrates a simplified schematic diagram of an example system for providing EPG data;

FIG. 2 illustrates an example EPG configuration process flow;

FIG. 3 illustrates an exemplary query process for retrieving and transmitting a program metadata object corresponding to a generalized program object of interest;

FIG. 4 illustrates an exemplary process for receiving and displaying EPG data by a client device;

FIG. 5 illustrates an example order confirmation dialog; and

FIG. 6 illustrates another example order confirmation dialog.

The skilled person in the art will understand that the drawings, described below, are for illustration purposes only. The drawings are not intended to limit the scope of the applicants' teachings in any way. Further, where considered appropriate, reference numerals may be repeated among the figures to indicate corresponding or analogous elements.

### DESCRIPTION OF VARIOUS EMBODIMENTS

At least some embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. For example and without limitation, the programmable computers may be a server, network appliance, set-top box, embedded device, computer expansion module, personal computer, laptop, personal data assistant, or mobile device. Program code is applied to input data to perform the functions described herein and generate output information. The output information is applied to one or more output devices, in known fashion. In some embodiments, the communication interface may be a network communication interface. In embodiments where elements of the invention are combined, the communication interface may be a software communication interface, such as those for inter-process communication (IPC). In still other embodiments, there may be a combination of communication interfaces.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a non-transitory computer readable medium that bears computer useable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Current electronic program guides (EPGs), such as those provided for Video-on-Demand (VOD) services are typically populated with several entries for each program asset (e.g., a particular film or show). Each entry may represent a different format (e.g., high definition or standard definition), language (e.g., English or French), or other option for that program asset. In particular, each program entry may appear separately although there may be only a slight difference in the options or metadata for each entry for a program asset. This can result in a large number of related or duplicated entries for a set-top box (STB) to download, and for a user to review when using traditional navigation means, such as, a remote control.

Also, currently if a user is not subscribed to a service, the subscription content that is offered via the service may still be displayed in EPG data, but unsubscribed users may receive an error message when attempting to view the content.

In many cases, STBs may have limited memory for storing EPG data, and therefore this duplication of entries for a number of assets can reduce the scope of EPG data that might otherwise be available for viewing on the STB. This issue may be further exacerbated in the future, as the number and variety of content options continues to increase.

In addition, providers of the entertainment content described in the EPG data may choose to organize the EPG according to content price or value. However, organization of content according to price or value can diminish the user experience and discourage users from using a service. In particular, organization of an EPG guide according to cost may not accommodate impulse viewing. For example, an EPG where fees are presented first, may deter users from purchasing a program.

Furthermore, current EPGs lack the ability to distinguish between various users and their television or set-top box capabilities. As a result, opportunities to employ variable pricing of content may be lost.

In addition, when a user makes a program selection, current VOD systems may present an order confirmation dialog that presents a standard price for the selected program asset. For example, the standard price may be identified in the EPG data or pre-programmed into the STB. However, the standard price may not take into account user account information, such as subscriptions, class (e.g., residential or commercial), etc. Moreover, different content types and user account options may have different cost models associated therewith. For example, a standard definition version of a program asset may have a lower price than a high definition version. Accordingly, a standard price may not be appropriate and could be misleading if accurate prices are not presented in the order confirmation dialog when the user makes the choice to proceed with an order.

Described herein are exemplary methods and systems that can facilitate reducing the number of program entries that initially appear in an EPG, to simplify navigation. For example, methods and systems described herein may provide for a single title with generic descriptive metadata for each asset to be displayed. Additional metadata for specific versions of the asset (e.g., different quality levels, languages, etc.) may be provided in response to a query from the user's STB. The metadata may be subsequently displayed to allow the user to select a preferred format, language and the like. Accordingly, duplicated entries in the EPG can be eliminated, thus easing navigation by the user, especially when using a remote control.

The provision of only generalized data in the initial EPG can also serve to optimize EPG delivery over a cable network.

Further, an order confirmation dialog, which provides the additional metadata once the user has selected a title, can expedite searches, encourage impulse purchases or subscriptions, and offer the opportunity to provide more targeted or specific information to that user. For example, if a user has a 3D TV and the program asset is available in 3D, the order confirmation dialog may present a corresponding 3D option. However, if the user only has a standard format television, the order confirmation dialog may only display the option to order the program in standard definition (SD).

In some cases, EPG data can be condensed into a reduced format for STBs to download so that users may navigate the EPG data conveniently. This may reduce the number of program entries for the user to review, so that only unique program guide entries relating to a specific program asset are seen by the user. For example, in a first EPG program view, the EPG may display generalized data about each program asset, such as title, synopsis and other metadata that can be common to all variants of a program asset. Once a user selects a program asset, an order confirmation dialog may present additional metadata or options for that particular program asset. For example, the order confirmation dialog may offer the user the opportunity to select a particular format, language, extras and the like.

Furthermore, various options may be automatically determined based on a user account, a user role or type, STB capability and the like. For example, language options may be automatically selected or filtered based on user account preferences. Pricing may be determined based on user account subscriptions, bundles or other considerations. Content formats may be determined based on ability of the STB to display the content. These options may be automatically determined by the content provider, the STB or some combination thereof.

There are further described exemplary methods and systems for offering variable pricing and content options depending on particular users. For example, users associated with a commercial account (e.g., at a restaurant or sports pub) may be offered a different price for particular content than users associated with a residential account.

In addition, an order confirmation dialog may allow users to subscribe to services interactively and immediately, or watch tutorials on how to obtain subscriptions or complete an order. As noted, users may be offered programmed preferences such as languages and output format selections tailored to a particular STB, television, or other display device (e.g., SD, HD, 3D). Finally, the dialog can be used to offer special promotions, advertisements, interactive coupons, targeted customer offerings and special pricings, based on a particular user's account or other characteristics.

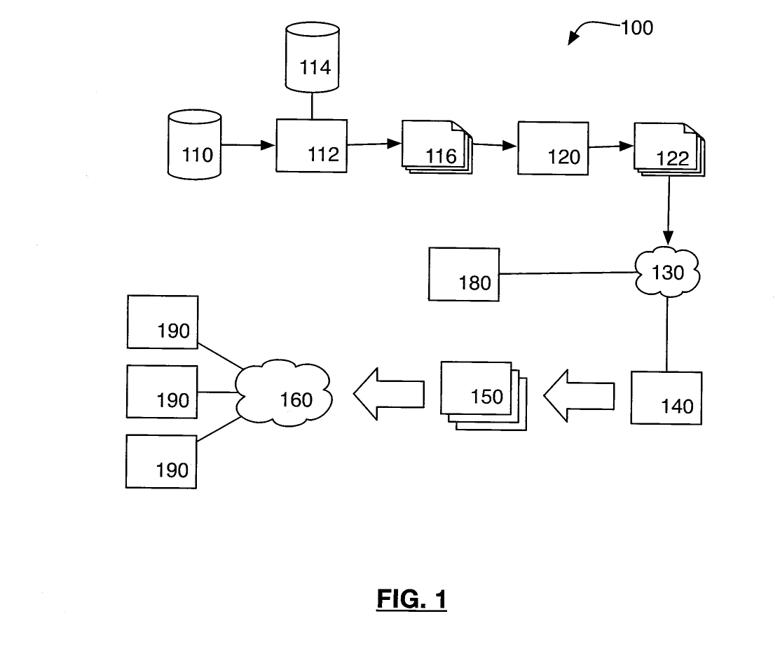

Referring now to FIG. 1, there is shown a simplified schematic diagram of an example system for providing EPG data. The system 100 comprises an EPG database 110, an EPG configuration module 112, which may have access to an EPG configuration database 114, a transcoding module 120, a distribution network 130, at least one carousel server 140, at least one cable headend 150, a cable network plant 160, at least one query server 180 and any suitable number of STBs 190. For clarity, only three STBs 190 are illustrated in FIG. 1.

Each asset (also referred to as a content item) in a VOD media library may have program listings or entries (also referred to as program data) associated therewith, and the program data may be stored in EPG database 110. For example, EPG database 110 may contain program data for a number of VOD content items and various metadata regarding each content item. A skilled person will be capable of configuring an EPG database 110 to store program data and metadata and this is not further described here.

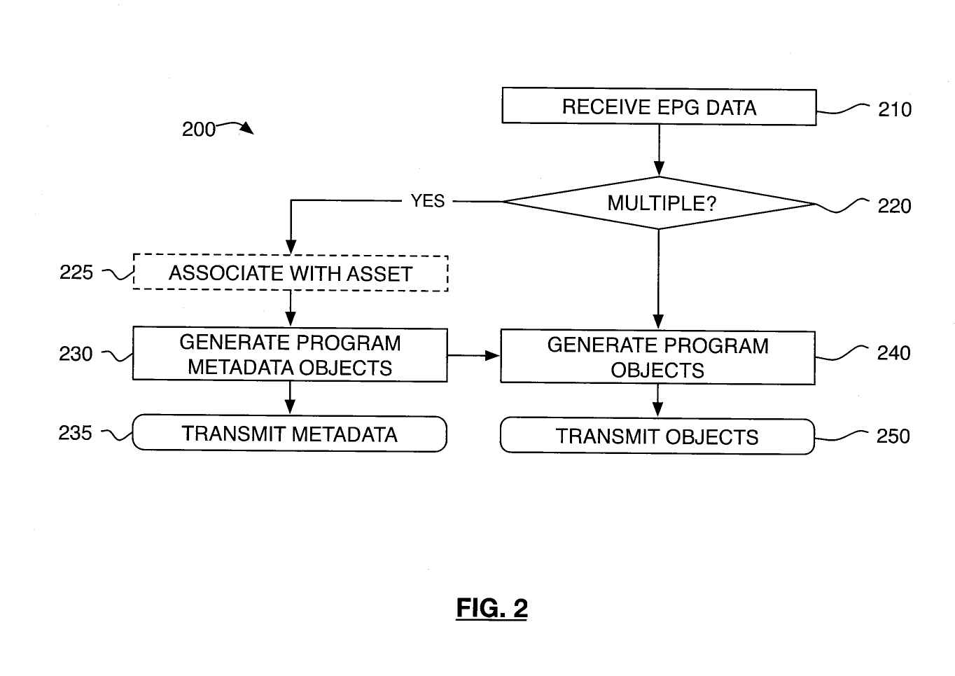

EPG configuration module 112 may be used to retrieve program data from EPG database 110, process the data and transmit the processed data to transcoding module 120. In particular, EPG configuration module 112 may employ templates when processing raw EPG data to determine how to format the processed EPG data. Templates may be stored, for example, in EPG configuration database 114. Once processed, the processed data may be transmitted to a transcoding module 120 in suitable a form, such as XML data files 116. Other formats may also be used. The operation of EPG configuration module 112 is further described herein with reference to FIG. 2.

For implementations on a cable or other such network, a transcoding module 120 may be used to convert the XML data files 116 into a format suitable for transmission via the cable plant. For example, transcoding module 120 may be configured to transcode XML data files 116 comprising processed EPG data into MPEG2 files 122. The MPEG2 files may be transmitted via a distribution network 130, such as a local or wide area network to populate at least one carousel server 140.

Carousel server 140 may receive the MPEG2 files comprising processed EPG data and transmit the MPEG2 files via IP multicast to a cable headend 150. It will be understood by those skilled in the art that any suitable number of headends 150 may be deployed. Accordingly, the cable headends may convert the MPEG2 streams into the appropriate RF format for broadcast using the RF network of the cable network plant 160. In some cases, other broadcast methods may be used.

STBs 190 can be set-top boxes provided to users or customers of the cable network operator. In some cases, STBs 190 may also comprise televisions or computing devices, which have a suitable decoder and processor to implement an EPG interface. STBs 190 can be connected to the cable network plant 160 via, for example, coaxial cable connections, and can thereby receive the MPEG2 stream comprising the processed EPG data.

Query server 180 can be configured to receive queries from STBs 190. In some cases, query server 180 can be a separate server connected and reachable via a data network, such as an IP network. In other cases, query server 180 may be integrated with a cable headend 150, a carousel server 140, or some other device. The operation of query server 180 is described further herein.

Referring now to FIG. 2, there is shown an example EPG configuration process flow. EPG configuration process flow 200 may be performed, for example, by EPG configuration module 112.

At step 210, EPG data may be received. EPG data may initially comprise raw data, which can be populated from a database, from flat files, manually or otherwise. The EPG data may comprise a plurality of program entries corresponding to a plurality of program assets. In some cases, EPG configuration module 112 may directly access an EPG database to obtain EPG data.

At decision diamond 220, the EPG data can be processed to identify if there is a set of multiple program entries associated with a particular program asset. If there is a set of related entries, these may be associated with each other, or the program asset may be identified, at step 225.

Each individual asset may have specific metadata associated therewith, including movie title, format, language, etc. It is expected that more and more assets will become available in several formats such as SD, HD and/or 3D. In order to prevent such assets from appearing as separate entries in an EPG, EPG configuration module 112 can identify related entries according to asset in the EPG data, based on title, asset ID, or other characteristics.

Accordingly, only one generalized program object will preferably be generated for each program asset, even if multiple program entries or options for the program asset exist in the received EPG data. However, in some cases, an exception may be made if desired so that more than one program object for a particular asset is created.

This may be necessary in some cases such as, for example, if it is desired for assets to have separate program objects for language, but not for quality level.

At step 230, the remaining program metadata corresponding to each of the set of related entries may be associated with the program asset (and the corresponding generalized program object) in the form of a program metadata object and stored in a database for later retrieval by, for example, query server 180.

If there is no set identified for a particular asset, EPG configuration module 112 may proceed to step 240.

Accordingly, for each program asset in the EPG data, EPG configuration module 112 may generate a generalized program object at step 240. The generalized program object may comprise generic data regarding the program asset, such as title, actors, and the like. Metadata specific to a particular program entry or option, such as data for a SD, HD or 3D version, for a particular language option, and pricing data may be omitted from the generalized program object.

In some cases, if an asset is unique (e.g., there is only one corresponding entry in the EPG data), the generalized program object may comprise all metadata for the asset.

At step 250, the generalized program objects can be transmitted to a distribution device, such as a carousel server, cable headend and the like, as described herein.

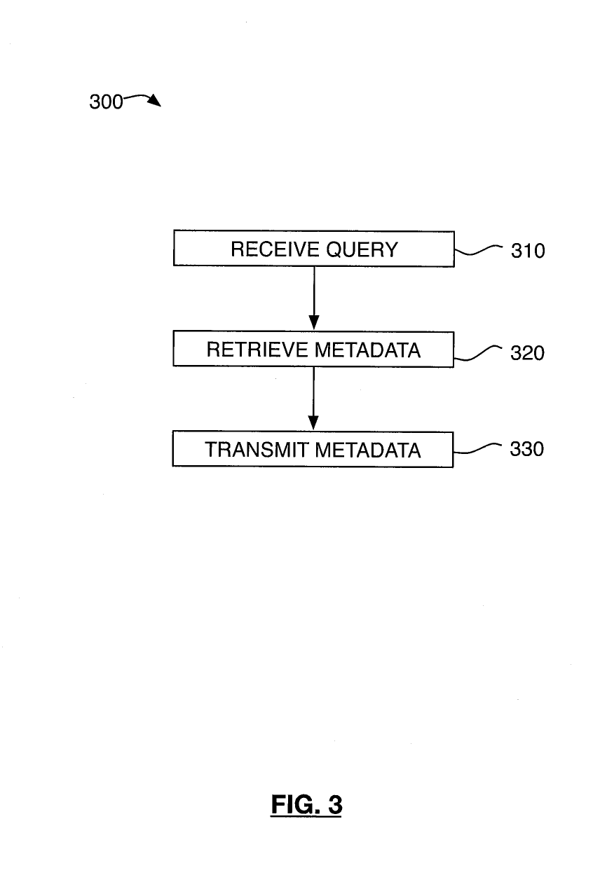

Referring now to FIG. 3, there is shown an exemplary query process for retrieving and transmitting a program metadata object corresponding to a generalized program object of interest. Query process 300 may be performed by, for example, query server 180.

At step 310, a query may be received from a device, such as an STB 190. The query may comprise one or more data packets, received via a data network, such as an IP-based network. In some other cases, the query may be received via other channels, such as telephone, wireless communication, or a reverse data channel provided in the cable network plant. In particular, the query may identify a specific generalized program object, which has been selected or identified by a user of the STB 190.

Query server 180 may identify the program metadata object corresponding to the generalized program object identified in the query and retrieve the associated program metadata object from its database at step 320.

Optionally, at step 320, query server 180 may identify query options specified in the query, which may comprise, for example, information regarding the requesting device (e.g., device capabilities), user account options and the like. In addition, query server 180 may determine similar information from a provider database (not shown).

Depending on the device capabilities, user account options and preferences, query server 180 may filter the program metadata object data that will be transmitted to the requesting device. Alternatively, query server 180 may simply transmit the complete program metadata object, and the requesting device may filter the metadata accordingly.

At step 330, query server 180 can format a response comprising the program metadata object and transmit a response to the requesting device. The response may be transmitted via a data network, or via another channel.

Upon receiving the query response, the requesting device can display an order confirmation dialog for the selected program asset comprising information from the generalized program object and the program metadata object, as described herein. If the user selects to receive the program asset, the requesting device can transmit an order request specifying the selected asset and asset options. For example, the requesting device may transmit a request for “Title: Example Film, Language: English, Quality: High Definition”. A skilled person will be capable of configuring a set-top box to transmit an order request and a content server to fulfill the order request.

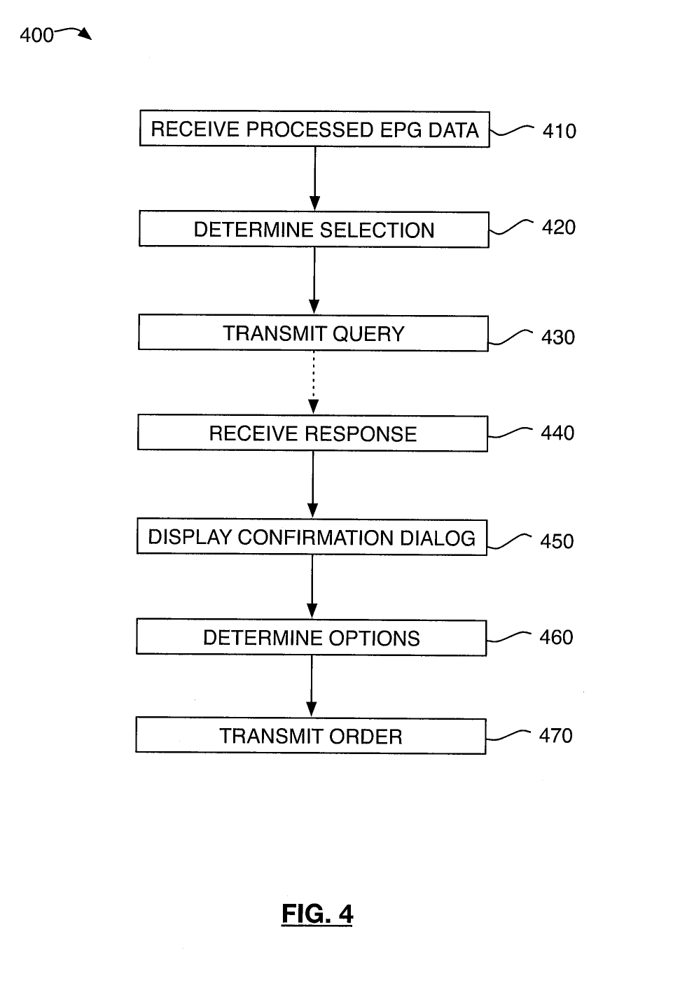

Referring now to FIG. 4, there is shown an exemplary process for receiving and displaying EPG data at a client device. Process 400 may be performed, for example, by a client device such as STB 190.

At step 410, the STB 190 may receive EPG data comprising a plurality of generalized program objects from, for example, a cable headend 150. The EPG data may be stored locally in memory of the STB 190 and may be used by the STB 190 to create an EPG to be transmitted to the user's television.

In operation, a user may navigate the local EPG data using a navigation menu system. When a user navigates to, or otherwise selects, a particular item corresponding to a program asset in the navigation menu at step 420, the information from the generalized program object corresponding to that program asset may be displayed.

The STB 190 may substantially simultaneously transmit a query to, for example, a query server 180, identifying the selected generalized program object. The query may comprise one or more data packets, transmitted via a data network, such as an IP-based network. In contrast, EPG data can be broadcast over a cable plant (e.g., encapsulated in an MPEG2 stream) to any suitable number of STBs 190. In some other cases, the data query may be transmitted via other channels, such as telephone, wireless communication, or a reverse data channel provided in the cable network plant.

In this manner, generalized data for all program assets described in the EPG data can be delivered to any suitable number of STBs 190. When a user navigates an EPG menu to select a particular program, the STB 190 can transmit an on-demand query to the query server 180 to receive additional data regarding the selected program.

Optionally, the STB 190 may include in query options in the query, which may comprise, for example, information regarding the requesting device (e.g., STB device capabilities), user account options and the like.

At step 440, the STB 190 may receive a query response comprising a program metadata object associated with the generalized program object identified in the query. The query response may comprise one or more data packets, transmitted via a data network, such as an IP-based network. In some other cases, the query response may be transmitted via other channels, such as telephone, wireless communication, or a reserved channel in the cable network plant.

Upon receiving the query response, the STB 190 can process the program metadata object to identify information of interest. Optionally, the STB 190 may filter the program metadata to remove information that may not be relevant to the particular user. For example, if the program metadata includes information regarding a 3D version, but the STB 190 cannot display 3D content, then the metadata regarding the 3D version may be filtered out and not displayed to the user.

At step 450, the client device can display an order confirmation dialog for the selected program asset comprising information from the generalized program object and the program metadata object.

If the user selects to receive the program asset, the STB 190 can determine which asset options, corresponding to a particular entry, the user has selected (e.g., quality level, language, etc.) at step 460.

Accordingly, the STB 190 can transmit a corresponding order request at step 470 specifying the selected asset and asset options. For example, the STB 190 may transmit a request for “Title: Example Film, Language: English, Quality: High Definition”.

In some cases, the user may elect to cancel the order confirmation dialog, in which case the client STB 190 may cancel display of the dialog and allow the user to continue navigating the EPG menu.

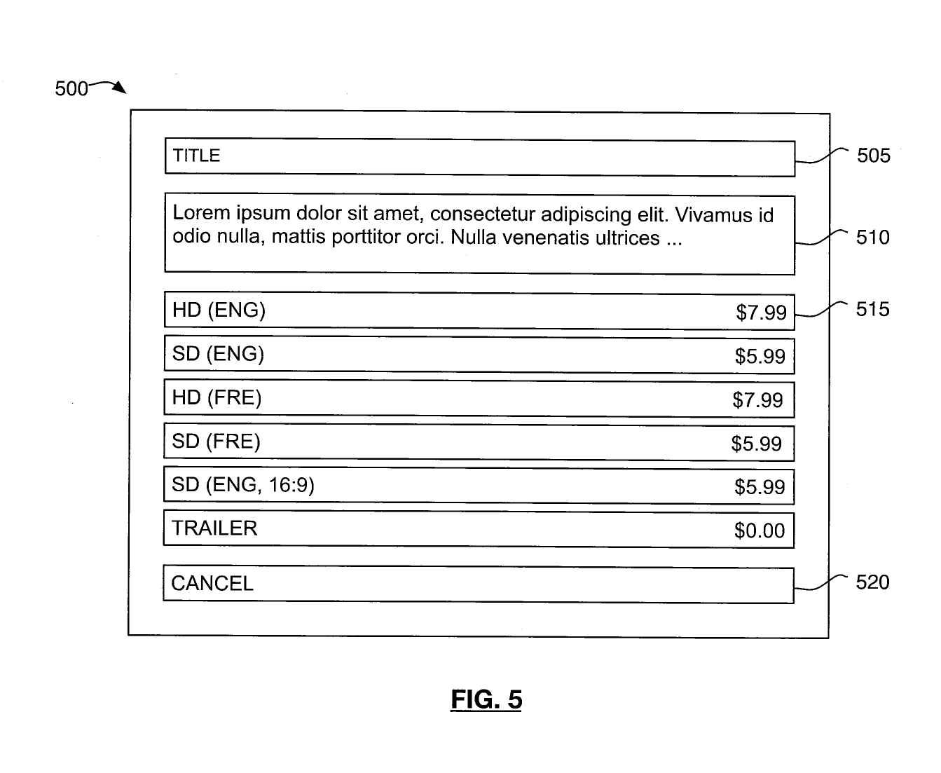

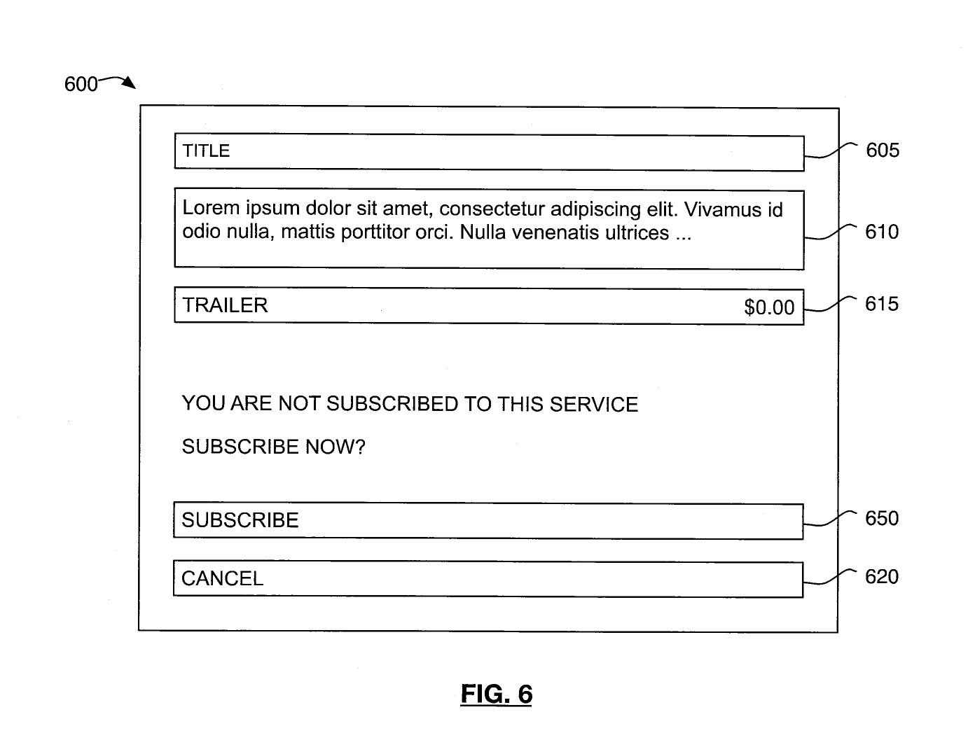

Referring now to FIGS. 5 and 6, there are shown example order confirmation dialogs, as may be used in the process 400.

Order confirmation dialog 500 may be generated by the STB 190 once a user selected a particular program asset. For example, the click of a remote control may be used to determine a program asset selection.

The order confirmation dialog may comprise, for example, a program asset title 505, program metadata 510 and one or more asset options 515.

Program metadata 510 may comprise a short description, long description, date of release, studio information, episode number, a list of actors, writers, directors, and the like.

Asset options 515 may comprise, different quality versions or formats, languages, and the like. Asset options 515 may also display the associated price for each option, where the price has been determined based on the user's account options, subscriptions, and the like.

Order confirmation dialog 600 is generally analogous to order confirmation dialog 500. However, order confirmation dialog 600 may be generated when it is determined that a user account does not have access to a selected program asset. This may occur, for example, where the user account is not subscribed to a particular service that includes access to the program asset.

If the user is not subscribed to the required service, order confirmation dialog 600 may present an available asset option (e.g., a free trailer) and a subscription option 650. Subscription option 650 may present information regarding the subscription service, or may lead to an immediate subscription process via the client device.

It will be appreciated that various embodiments may comprise one or more special purpose or general purpose computers or servers, each of which may include, but are not limited to, one or more processors, memories, storage devices, input/output devices and network interfaces. Likewise, the terms ‘computer’ and ‘server’ may be interchangeable in accordance with the above description. Furthermore, embodiments may be implemented as computer software instructions stored on a computer readable medium and executed in memory by processors on one or more of the computers or servers contemplated above. Although embodiments have been described as separate components, it will be understood that various components could be combined into a single computer or server, or implemented across multiple computers or servers all connected via a communications medium such as the Internet.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method of providing EPG data, the method comprising:
generating a plurality of generalized program objects based on a plurality of program assets in the EPG data;
transmitting the plurality of generalized program objects from a distribution device to a plurality of client devices;
receiving, at a server, a query from a first client device of the plurality of client devices, the query identifying a first generalized program object from the plurality of generalized program objects; and
providing, from the server to the first client device, a program metadata object associated with the first generalized program object, the program metadata object comprising additional data associated with the first generalized program object.

2. The method of claim 1, further comprising, prior to generating the plurality of generalized program objects:
receiving the EPG data; and
identifying a set of program entries in the EPG data, each of the set of program entries associated with a specific program asset,
wherein only one of the plurality of generalized program objects is generated based on the set of program entries.

3. The method of claim 1, further comprising, prior to providing the program metadata object, determining at least one device capability of the first client device.

4. The method of claim 1, wherein the query identifies at least one device capability of the first client device.

5. The method of claim 3, wherein the additional data associated with the first generalized program object is based on the at least one device capability of the first client device.

6. The method of claim 1, further comprising, prior to providing the program metadata object, determining at least one account option associated with a user of the first client device.

7. The method of claim 1, wherein the query further identifies at least one account option associated with a user of the first client device.

8. The method of claim 6, wherein the additional data associated with the first generalized program object is based on the at least one account option associated with a user of the first client device.

9. The method of claim 6, wherein the at least one account option includes a subscription.

10. The method of claim 1, wherein the distribution device is a cable headend.

11. The method of claim 1, wherein the plurality of generalized program objects is transmitted to the plurality of client devices via a cable plant.

12. The method of claim 11, wherein the query comprises at least one data packet received from the first device via an IP network.

13. A method of displaying EPG data on a client device, the method comprising:
receiving a plurality of generalized program objects based on a plurality of program assets;
displaying the plurality of generalized program objects in an EPG menu;
receiving a selection of a first generalized program object from the plurality of generalized program objects;
generating a query identifying the first generalized program object;
transmitting the query to a server;
receiving, from the server, a program metadata object associated with the first generalized program object, the program metadata object comprising additional data associated with the first generalized program object; and
displaying data from the program metadata object in association with the first generalized program object in an order confirmation dialog.

14. The method of claim 13, further comprising, prior to transmitting the query, determining at least one device capability of the client device.

15. The method of claim 13, wherein the query identifies at least one device capability of the client device.

16. The method of claim 13, wherein the plurality of generalized program objects is received from a cable plant.

17. The method of claim 13, wherein the query comprises at least one data packet transmitted to the server via an IP network.

18. A system for providing and displaying EPG data, the system comprising:
an EPG configuration module, the EPG configuration module configured to generate a plurality of generalized program objects based on a plurality of program assets associated with the EPG data;
at least one distribution device, the distribution device configured to transmit the plurality of generalized program objects to a plurality of client devices;
a server configured to received a query identifying a first generalized program object from the plurality of generalized program objects and transmit a program metadata object associated with the first generalized program object; and
a first client device in the plurality of client devices, the first client device configured to:
receive the plurality of generalized program objects;
display the plurality of generalized program objects in an EPG menu;
receive a selection of the first generalized program object from the plurality of generalized program objects;
generate the query identifying the first generalized program object;
transmit the query to the server;
receive, from the server, the program metadata object associated with the first generalized program object; and
display data from the program metadata object in association with the first generalized program object in an order confirmation dialog.
